(19) United States
(12) Patent Application Publication
(10) Pub. No.: US 2021/0173123 A1
(43) Pub. Date: Jun. 10, 2021

(54) ARTICLE INCLUDING FILM, COATING MATERIAL, METHOD FOR PRODUCING ARTICLE

(71) Applicant: CANON KABUSHIKI KAISHA, Tokyo (JP)

(72) Inventor: Yo Watanabe, Tokyo (JP)

(21) Appl. No.: 17/110,155

(22) Filed: Dec. 2, 2020

(30) Foreign Application Priority Data
Dec. 6, 2019 (JP) 2019-221443

(51) Int. Cl. G02B 1/11; G02B 7/02; C08K 3/22; C08K 3/36; C08L 33/04; C09D 7/61; C09D 133/04

(52) U.S. Cl. CPC G02B 1/11; G02B 7/02; C08K 3/22; C08K 3/36; C08K 2201/005; C09D 7/61; C09D 133/04; C08K 2003/2237; C08K 2201/011; C08L 33/04

(57) ABSTRACT

An article includes a film on a base member, the film at least containing a resin, first particles, and third particles containing second particles in a base material.

### BACKGROUND OF THE INVENTION

### Field of the Invention

The present invention relates to an article including a film, a coating material, and a method for producing an article. In particular, the present invention relates to a film and a coating material, the film being disposed on a surface of a lens barrel for an optical apparatus, such as a camera, a camcorder, or broadcast equipment, or on another optical apparatus, such as a camera body, a surveillance camera, or a weather camera, that can be used outdoors.

### Description of the Related Art

Films disposed on surfaces of optical apparatuses, such as cameras, camcorders, and broadcast equipment, are required to have good designs and functionality. For example, when an optical apparatus can be touched by a person at the time of photographing, fingerprints, oils and fats, and so forth often adhere to the optical apparatus. Thus, the optical apparatus is required to have smudge resistance. Regarding coating materials used for optical apparatuses, a film composed of a hydrophobic coating material is less likely to leave smudges. A film composed of a hydrophilic coating material can be wetted with smudges and allows the smudges to run. In this way, the smudge resistance can be enhanced. A technique is also known for reducing the leaving of smudges by using a surface having an uneven structure to reduce the contact area between smudges and the surface.

Such optical apparatuses are often used outdoors and thus are also required to have heat-shielding properties, i.e., reflect or diffuse sunlight, under harsh sunlight conditions in equatorial regions and other regions in addition to the smudge-resistant function.

International Publication No. 2013/176181 discloses a film having an uneven surface structure formed by the incorporation of resin beads into a coating material to enhance light diffusibility.

In International Publication No. 2013/176181, although the uneven structure reduces leaving fingerprints, the film cannot effectively reflect sunlight because of the transmission of sunlight through the resin beads and thus is less effective in shielding heat. In the case where an optical apparatus is used under harsh sunlight conditions in the equatorial region or the like, for example, the deformation of a base may deteriorate the performance of the optical apparatus.

### SUMMARY OF THE INVENTION

To solve the foregoing problems, the present invention provides an article including a film on a surface thereof, the film having excellent smudge resistance for preventing leaving smudges, such as fingerprints, and having excellent heat-shielding properties against sunlight, and a coating material.

According to one aspect of the present invention, an article includes a film on a base member, the film at least containing a resin, first particles, and third particles containing second particles in a base material.

According to another aspect of the present invention, a coating material contains a resin, first particles, and third particles containing second particles in a base material.

Further features of the present invention will become apparent from the following description of exemplary embodiments with reference to the attached drawings.

### BRIEF DESCRIPTION OF THE DRAWINGS

FIG. 1 schematically illustrates a first embodiment.

FIG. 2A is an external view of an optical apparatus according to an embodiment of the present invention, and FIG. 2B is a sectional view of an optical apparatus.

FIG. 3 is a schematic view illustrating a method for evaluating a heat-shielding effect.

### DESCRIPTION OF THE EMBODIMENTS

Embodiments of the present invention will be described in detail below.

The following structures are merely examples. For example, those skilled in the art can appropriately change the detailed structures without departing from the spirit of the present invention.

### First Embodiment

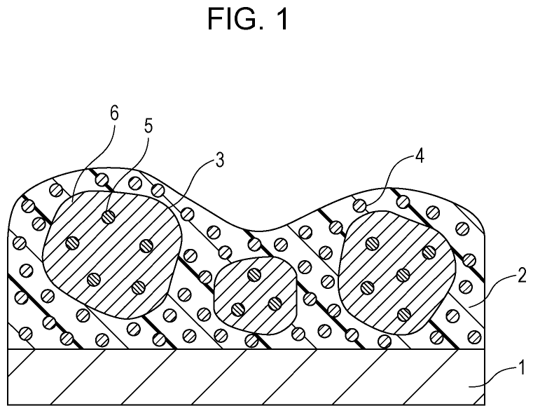

FIG. 1 is a partial cross-sectional view of an example of an article according to a first embodiment of the present invention. In FIG. 1, reference numeral 1 denotes a base member. Reference numeral 2 denotes a resin. Reference numeral 4 denotes first particles composed of a first material. Reference numeral 3 denotes third particles containing the first particles 4 composed of the first material or second particles 5 composed of a second material in a base material 6. A coating material according to the embodiment is applied to the base member 1 composed of a plastic material or a metal to form a film having excellent heat-shielding performance, i.e., a film according to the embodiment, on a surface of the base member 1.

The article according to the embodiment includes the film having excellent heat-shielding performance, i.e., the film according to the embodiment, on the surface thereof. As will be described in detail below, the article according to the embodiment can be particularly used for an optical apparatus. Examples of the optical apparatus include interchangeable lenses, for example, for cameras, camcorders, and broadcast equipment. In the case where the article is an interchangeable lens, the film according to the embodiment is disposed on a portion of the base member 1 of the interchangeable lens to be irradiated with sunlight (referred to as an “outer surface”) when the interchangeable lens is used outdoors, and the interchangeable lens has a holding unit configured to hold lens elements inside the base member 1.

The optical apparatus may also be, for example, a camera body, a camcorder body, surveillance camera, or a weather camera, which is an image forming apparatus configured to form an image using light passing through its lens and which is possibly used outdoors. The optical apparatus according to the embodiment includes the film according to the embodiment disposed on a portion of the optical apparatus to be irradiated with sunlight (referred to as an “outer surface”) when used outdoors, and thus provides a higher heat-shielding effect. The optical apparatus according to the embodiment includes an electronic device inside the base member 1 on which the film according to the embodiment is disposed on the outer surface and can suppress the influence of heat on the electronic device.

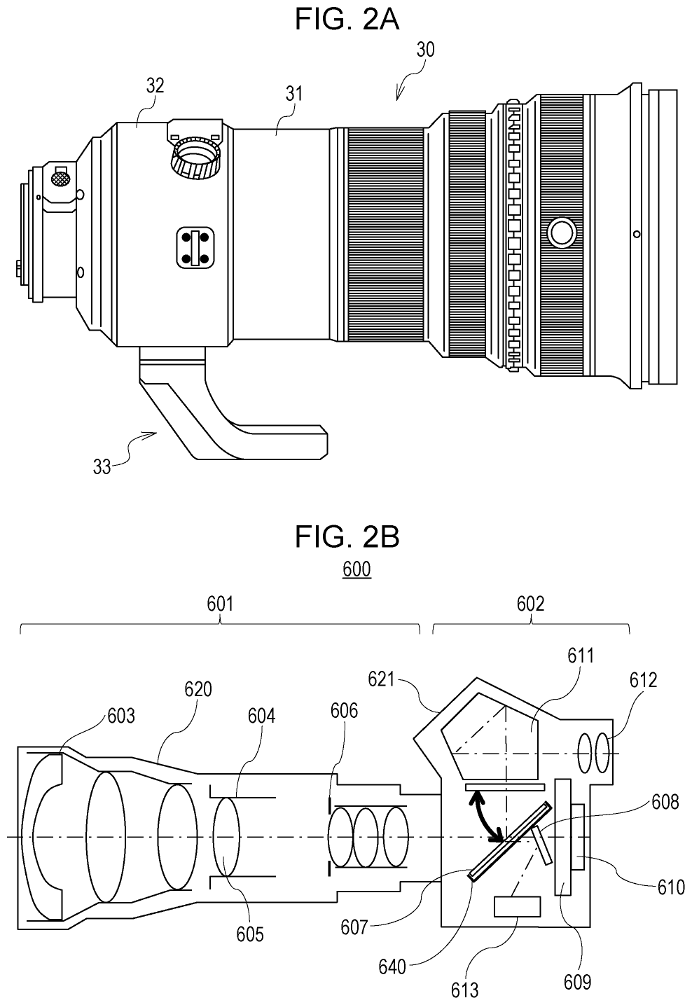

FIG. 2A illustrates the appearance of an interchangeable camera lens including a lens barrel having a holding unit configured to hold lens elements, as an example of the optical apparatus according to the embodiment. The interchangeable lens includes a lens barrel 30 and a tripod mount 33. The lens barrel 30 includes lens elements, a stationary barrel 31, an annular member 32, and other components. The optical apparatus according to the embodiment includes films excellent in heat-shielding performance, i.e., films according to the embodiment, on surfaces of the stationary barrel 31 and the annular member 32 of the lens barrel 30, the tripod mount 33, and other components. A decrease in accuracy can be suppressed by suppressing the deformation of the stationary barrel 31, the annular member 32, the tripod mount 33, and other components due to heat, thereby enabling the formation of highly accurate images. The material of each of the stationary barrel 31, the annular member 32, and the tripod mount 33 may be, but is not particularly limited to, a plastic material or a metal.

The film according to the embodiment at least contains the resin 2, the first particles 4 composed of the first material, and the third particles 3 containing the particles composed of the first material or the second particles 5 composed of the second material in the base material 6. The film according to the embodiment contains the third particles 3 containing the particles composed of the first material or the second particles 5 composed of the second material in the base material 6 and thus has an uneven surface. This is less likely to cause leaving smudges. The film also reflects visible and near-infrared light to improve heat-shielding performance. In the present specification, the particles 3 containing the particles 5 in the base material 6 are referred to as “third particles”, and the particles 5 contained in the base material 6 are referred to as “second particles”.

The base material 6 of the third particles 3 may be composed of any material and can be composed of a resin with high transparency and low specific gravity. For example, the base material 6 may contain one or more resins selected from acrylic resins, epoxy resins, polyester resins, polyolefin resins, polyurethane resins, and melamine resins. The type thereof can be selected in accordance with the base member, applications, and so forth.

The first particles 4 and the second particles 5, which are contained in the base material 6, may each be composed of any material having high visible or near-infrared reflectance. For example, one material selected from titanium oxide, barium sulfate, zinc oxide, zinc sulfide, zinc sulfate, barium sulfate, calcium carbonate, and aluminum oxide may be used. A mixture of two or more materials selected therefrom may also be used. Among these, a main component can be titanium oxide having high visible or near-infrared reflectance and can be rutile titanium oxide. The use of rutile titanium oxide as a main component results in high lightfastness in addition to high visible or near-infrared reflectance.

To further enhance the lightfastness and so forth, the second particles may be titanium oxide particles whose surfaces are covered with, for example, silica, zirconia, or alumina. The material of the first particles 4 and the material of the second particles 5 may be the same or different.

The third particles 3 according to the embodiment can have a spherical shape in order to form an uneven structure. The term “spherical shape” used in the present specification refers to a shape with an average circularity of 0.8 or more. An average circularity of 0.8 or more is determined as follows: Five cross-sectional samples of the film are taken and magnified with a microscope. Ten cross-sections of the third particles 3 are observed for each sample. The average circularity of the 10 cross sections×5 samples of the third particles 3 is 0.8 or more. The circularity is calculated from the following formula:

Circularity=4π(cross-sectional area)/(cross-sectional perimeter)²

The third particles 3 preferably have an average particle size of more than 1 μm and 50 μm or less, more preferably 10 μm or more and 30 μm or less. When the third particles 3 according to the embodiment have an average particle size of 1 μm or less, the uneven structure is not easily formed, thus easily leaving smudges. At more than 50 μm, the third particles 3 may be exposed at a surface of the film. The exposure of the third particles 3 deteriorates the design. In the present specification, the third particles 3 are defined as particles having an average particle size of 1 μm or more and 50 μm or less. The average particle size of the third particles 3 is a number-average particle size. In the state of a coating material before application, the average particle size can be measured by a dynamic light scattering method. In the case where the average particle size is measured in the state of a film, the measurement is performed as follows: Cross-sectional samples are taken at five locations of the film according to the embodiment and magnified with a microscope. In the present specification, the cross section of the film refers to a cross section cut out in the direction parallel to a direction normal to a surface of the film. In the case where the film has a surface having irregularities, the direction normal to the surface of the film refers to a direction normal to a plane connecting protruding portions. The third particles 3 located at the five locations are subjected to surface analysis by energy dispersive X-ray spectroscopy (EDS) to determine the particle sizes of the individual third particles 3. Then the average particle size is calculated. In the present specification, the maximum transverse length of each particle is defined as a particle size. The sizes of 10 or more particles per location are measured, and then the average size is calculated. Finally, the average particle sizes at the five locations are averaged. The resulting average value at the five locations is defined as the average particle size of the third particles 3 contained in the film according to the embodiment.

The amount of the third particles 3 contained in the film is preferably 5% or more by area and 80% or less by area, more preferably 30% or more by area and 60% or less by area. When the amount of the third particles 3 contained is less than 5% by area, the uneven structure may be sparsely distributed to deteriorate the smudge resistance. When the amount of the third particles 3 contained is more than 60% by area, adhesion to the base member may be deteriorated. The amount of the third particles 3 contained in the film according to the embodiment can be measured as follows: Cross sections of the film according to the embodiment are taken at five locations and magnified with a microscope. The cross sections of the film are cut out in the direction parallel to a direction normal to a surface of the film. The third particles 3 located at the five locations are subjected to surface analysis by energy dispersive X-ray spectroscopy (EDS) to calculate the amounts of the third particles 3 contained per unit area. Finally, the amount of the third particles 3 contained in the film according to the embodiment is calculated from the average values at the five locations, and the resulting value is defined as the amount of the third particles 3 contained in the film (% by area).

The first particles 4 preferably have an average particle size of 10 nm or more and 5 μm or less, more preferably 100 nm or more and 1 μm or less. When the first particles 4 according to the embodiment have an average particle size of less than 10 nm, visible or infrared light cannot be effectively reflected, thereby deteriorating the heat-shielding performance. When the first particles 4 according to the embodiment have an average particle size of more than 5 μm, it is difficult to uniformly disperse the first particles 4 in the resin 2; thus, the heat-shielding performance may be deteriorated. The amount of the first particles 4 contained (% by area) with respect to the resin 2 is preferably 10% or more by area and 80% or less by area, more preferably 30% or more by area and 60% or less by area. At less than 10% by area, the heat-shielding performance is deteriorated. At more than 80% by area, the film is brittle and thus is easily cracked, for example, in an environment where the temperature changes rapidly.

The amount of the first particles 4 contained in the film according to the embodiment with respect to the resin 2, in other words, the percentage by area of the first particles when the area of the resin in a section is defined as 100% by area, can be measured as follows: Cross sections of the film are taken at five locations and magnified with a microscope. The cross sections of the film are cut out in the direction parallel to a direction normal to a surface of the film. In the case where the film has a surface having irregularities, the direction normal to the surface of the film refers to a direction normal to a plane connecting protruding portions. The resin 2 and the first particles 4 located at the five locations are subjected to surface analysis by energy dispersive X-ray spectroscopy (EDS) to determine the percentage by area of the first particles 4 when the area of the resin 2 in a section is defined as 100% by area.

The first particles 4 preferably have an average particle size 10 nm or more and 5 μm or less, more preferably 100 nm or more and 1 μm or less. When the first particles 4 according to the embodiment have an average particle size of less than 10 nm, visible or infrared light cannot be effectively reflected, thereby deteriorating the heat-shielding performance. When the first particles 4 according to the embodiment have an average particle size of more than 5 μm, it is difficult to uniformly disperse the first particles 4 in the resin; thus, the heat-shielding performance may be deteriorated.

The average particle size of the first particles 4 is a number-average particle size. In the state of a coating material before application, the average particle size can be measured by a dynamic light scattering method. In the case where the average particle size is measured in the state of a film, the measurement is performed as follows: Cross-sectional samples are taken at five locations of the film according to the embodiment and magnified with a microscope. The first particles 4 located at the five locations are subjected to surface analysis by energy dispersive X-ray spectroscopy (EDS) to determine the particle sizes of the individual first particles 4. Then the average particle size is calculated. The sizes of 10 or more particles per location are measured, and then the average size is calculated. Finally, the average value of the average particle sizes at the five locations is calculated. The resulting average value at the five locations is defined as the average particle size of the first particles 4 contained in the film according to the embodiment.

The amount of the second particles 5 (% by area) contained in the film according to the embodiment with respect to the base material may be 5% or more by area and less than or equal to the amount of the first particles 4 contained (% by area) with respect to the resin. In the embodiment, the amount of the second particles 5 contained (% by area) with respect to the base material is the percentage by area of the second particles 5 when the area of the base material in a section is defined as 100% by area. At less than 5% by area, the third particles 3 as a whole highly transmit visible or infrared light and thus cannot efficiently eject the light to the outside of the film. At more than the amount of the first particles 4 contained (% by area) with respect to the resin, light incident on the third particles 3 is confined in the third particles 3 and thus cannot emerge from the film. The inventors have found that the film even containing the large-size particles (the third particles) mainly containing the highly transparent resin can provide desired heat-shielding performance by the incorporation of the small second particles in the large-size particles (the third particles.

The amount of the second particles 5 (% by area) contained in the film according to the embodiment with respect to the base material can be measured as follows: Cross sections of the film according to the embodiment are taken at five locations and magnified with a microscope. The cross sections of the film are cut out in the direction parallel to a direction normal to a surface of the film. The third particles 3 located at the five locations are subjected to surface analysis by energy dispersive X-ray spectroscopy (EDS) to calculate the area of the base material and the area of the second particles contained in the third particles. The percentage by area of the second particles is determined when the area of the base material is defined as 100% by area. The percentages by area of the second particles in the individual five sections when the area of the base material is defined as 100% by area are determined and averaged. The resulting average value is defined as the amount of the second particles 5 contained (% by area) with respect to the base material.

The film according to the embodiment can have a lightness of 50 or more and 80 or less. The lightness of the film can be adjusted to 50 or more by adjusting the amount of the first particles and the amount of the second particles contained in the third particles. In the embodiment, when the film has a lightness of less than 50, the solar reflectance is decreased to deteriorate the effect of reducing the temperature. When the film formed from the coating material according to the embodiment has a lightness of more than 80, the film has an excessively high degree of whiteness; thus, smudges may be noticeable.

### Resin

The amount of the resin 2 contained in the film according to the embodiment is preferably 5% or more by area and 80% or less by area, more preferably 30% or more by area and 60% or less by area. When the amount of the resin 2 contained in the film according to the embodiment is less than 5% by area, adhesion to the base member may be deteriorated. When the amount of the resin 2 contained in the film according to the embodiment is more than 60% by area, the uneven structure having smudge resistance may not be obtained. Non-limiting examples of the resin 2 contained in the film according to the embodiment include cured products of epoxy resins, urethane resins, acrylic resins, urethane-acrylic resins, phenolic resins, or alkyd resins. Such a cured resin product may be composed of a single resin or may contain multiple resins. The resin 2 may be composed of the same material as the base material of the third particles.

The amount of the resin 2 contained in the film according to the embodiment can be measured as follows: The amount of the third particles 3 (% by area) contained in the film according to the embodiment is calculated by the method described above. Cross sections of a portion of the film that contains no third particles 3 are taken at five locations and magnified with a microscope. The resin portions located at the five locations are subjected to surface analysis by energy dispersive X-ray spectroscopy (EDS) to determine the percentage of the resin 2 when the area of each section is defined as 100% by area. For example, let us suppose that the area of the resin 2 contained in the section is 50% by area when the area of the section is defined as 100% by area. The amount of the resin 2 (% by area) contained in a region having an area percentage determined by subtracting the amount of the third particles 3 contained (% by area) from 100% is calculated. For example, in the case where the amount of the third particles 3 contained is 40% by area, the area percentage of the region determined by subtracting the amount of the third particles 3 contained (% by area) from 100% is 60% by area. When the region having an area percentage of 60% by area contains 50% by area of the resin, the amount of the resin 2 contained in the film according to the embodiment is 30% by area. Finally, the values at the five locations are averaged, and the resulting average value is defined as the amount of the resin 2 (% by area) contained in the film.

### Base Member

As the base member, any material can be used. A metal or a plastic material can be used. Examples of the metal material include aluminum, titanium, stainless steel, magnesium alloys, and lithium-magnesium alloys. Examples of the plastic material include polycarbonate resin, acrylic resins, ABS resins, fluorocarbon resins, polyester resins, melamine resins, and vinyl chloride resins.

The base member can have any thickness, preferably has a thickness of 0.5 mm or more and 5 mm or less, more preferably 0.5 mm or more and 2 mm or less. At a thickness of less than 0.5 mm, it is difficult to maintain the shape of the lens barrel. At a thickness of more than 5 mm, the cost of the member is increased.

### Primer

The base member may include a primer at the interface with the film in order to improve adhesion to the film.

As the primer, any material can be used. Examples thereof include epoxy resins, urethane resins, acrylic resins, silicone resins, and fluorocarbon resins. The primer may contain the particles according to the embodiment and particles other than the particles according to the embodiment. The primer may further contain a colorant, a dispersant, a curing agent, a curing catalyst, a plasticizer, a thixotropy imparting agent, a leveling agent, an organic colorant, an inorganic colorant, a preservative, an ultraviolet absorber, an antioxidant, a coupling agent, and the residue of a solvent.

The primer preferably has a thickness of 2 μm or more and 30 μm or less, more preferably 5 μm or more and 20 μm or less. A thickness of less than 2 μm may result in a decrease in the adhesion of the film. A thickness of more than 30 μm may result in an adverse effect on positional accuracy as an optical apparatus.

In the present specification, both the base member and the primer may be collectively referred to as a base member. That is, the base member may include the primer in the present specification.

### Thickness of Film

The film according to the embodiment can have a thickness of 20 μm or more and 70 μm or less. A thickness of less than 20 μm may result in a decrease in solar reflectance. A thickness of more than 70 μm may result in an adverse effect on positional accuracy as an optical apparatus.

### Particles for Adjusting Lightness of Film

The film according to the embodiment may contain particles (colorant) for adjusting lightness in addition to the first particles and the second particles. The material of the particles is not particularly limited. The particles can contain azo-based organic particles with high infrared reflection performance. As the azo-based organic particles, particles composed of any azo group-containing compound can be used. Examples of the color of the azo-based organic particles contained in the film according to the embodiment include black-based colors, yellow-based colors, red-based colors, and orange-based colors. Black-based colors can be used because of a small change in tint (a*, b*) when fading due to sunlight occurs. A material having high solar reflectance can be used. A material in which the solar reflectance of azo-based organic particles alone is more than 10% can be selected. Examples of the material of the azo-based organic particles include nickel azo pigments, insoluble azo-based pigments, soluble azo-based pigments, high-molecular-weight azo-based pigments, azomethine azo-based pigments. These materials of the azo-based organic particles may be contained alone or in combination.

The azo-based organic particles contained in the film according to the embodiment preferably has an average particle size of 10 nm or more and 5 μm or less, more preferably 50 nm or more and 2 μm or less. An average particle size of less than 10 nm results in an increase in the surface area of the particles to deteriorate the lightfastness, thereby possibly causing discoloration. An average particle size of more than 5 μm makes it difficult to uniformly disperse the particles in the film, thereby possibly deteriorating the heat-shielding performance. The average particle size of the azo-based organic particles is a number-average particle size. In the state of a coating material before application, the average particle size can be measured by a dynamic light scattering method. In the case where the average particle size is measured in the state of a film, the measurement is performed as follows: Cross-sectional samples are taken at five locations of the film according to the embodiment and magnified with a microscope. The cross sections of the film are cut out in the direction parallel to a direction normal to a surface of the film. In the case where the film has a surface having irregularities, the direction normal to the surface of the film refers to a direction normal to a plane connecting protruding portions. The azo-based organic particles located at the five locations are subjected to surface analysis by energy dispersive X-ray spectroscopy (EDS) to determine the particle sizes of the individual azo-based particles. Then the average value of the particle sizes is calculated. In the present specification, the maximum transverse length of each particle is defined as a particle size. The sizes of 10 or more particles per location are measured, and then the average size is calculated. Finally, the average particle sizes at the five locations are averaged. The resulting average value at the five locations is defined as the average particle size of the azo-based organic particles contained in the film according to the embodiment.

The amount of the azo-based organic particles contained in the film according to the embodiment is preferably 0.1% or more by area and 0.4% or less by area, more preferably 0.15% or more by area and 0.3% or less by area. When the amount of the azo-based organic particles contained is less than 0.1% by area, the film has excessively high lightness; thus, smudge resistance is deteriorated. When the amount of the azo-based organic particles contained is more than 0.4% by area, the film has insufficient lightness; thus, the solar reflectance is deteriorated. The amount of the azo-based organic particles contained in the film according to the embodiment can be measured as follows: The amount of the third particles 3 (% by area) contained in the film according to the embodiment is calculated by the method described above. Cross sections of a portion of the film that contains no third particles 3 are taken at five locations and magnified with a microscope. The resin portions located at the five locations are subjected to surface analysis by energy dispersive X-ray spectroscopy (EDS). The amount of the azo-based organic particles (% by area) contained in a region having an area percentage determined by subtracting the amount of the third particles 3 contained (% by area) from 100% is calculated. For example, let us suppose that the amount of the third particles 3 contained is 40% by area, the area percentage of the region determined by subtracting the amount of the third particles 3 contained (% by area) from 100% is 60% by area. When the region having an area percentage of 60% by area contains 1% by area of the azo-based organic particles, the amount of the azo-based organic particles contained is 0.6% by area. Finally, the values at the five locations are averaged, and the resulting average value is defined as the amount of the azo-based organic particles (% by area) contained in the film.

### Silica Particles

The film according to the embodiment may further contain silica particles. The silica particles can have an average particle size of 10 nm or more and 5 μm or less. When the silica particles according to the embodiment has an average particle size of less than 10 nm, the uneven surface structure is not easily formed; thus, smudges are easily left. An average particle size of more than 5 μm results in an increase in the unevenness of the coating film, thereby possibly deteriorating the positional accuracy as an optical apparatus.

The silica particles can have any shape. Examples of the shape of the silica particles include spherical shapes, indefinite shapes, star shapes, chain shapes, hollow shapes, and porous shapes. These silica particles may be contained alone or in combination.

The particle size of the silica particles according to the embodiment is a number-average particle size. In the state of a coating material before application, the average particle size of the silica particles can be measured by a dynamic light scattering method. In the case where the average particle size is measured in the state of a film, the measurement is performed as follows: Cross-sectional samples are taken at five locations of the film according to the embodiment and magnified with a microscope. The silica particles located at the five locations are subjected to surface analysis by energy dispersive X-ray spectroscopy (EDS) to determine the particle sizes of the individual silica particles. The sizes of 10 or more particles per location are measured, and then the average size is calculated. Finally, the average particle sizes at the five locations are averaged. The resulting average value at the five locations is defined as the average particle size of the silica particles contained in the film according to the embodiment.

### Other Additives

The film according to the embodiment may further contain other freely-selected additives. Examples thereof include dispersants, curing agents, curing catalysts, plasticizers, thixotropy imparting agents, leveling agents, flatting agents, preservatives, ultraviolet absorbers, antioxidants, coupling agents, and fine inorganic particles and fine organic particles other than those described above for the purpose of adjusting the tint.

### Coating Material

Next, the coating material according to the embodiment and a method for producing the coating material will be described below.

The coating material according to the embodiment at least contains a resin, first particles, and third particles containing second particles.

### Third Particles

A base material 26 of third particles 15 contained in the coating material according to the embodiment may be composed of any material and can be composed of a resin with high transparency and low specific gravity. For example, the base material 26 may contain one or more resins selected from acrylic resins, epoxy resins, polyester resins, polyolefin resins, polyurethane resins, and melamine resins.

Second particles 17 contained in the third particles 15 may be composed of any material. Examples of a material that can be used include titanium oxide, barium sulfate, zinc oxide, zinc sulfide, zinc sulfate, barium sulfate, calcium carbonate, and aluminum oxide. Among these, titanium oxide having high visible or near-infrared reflectance can be used. To further enhance the lightfastness and so forth, the second particles 17 may be particles whose surfaces are covered with, for example, silica, zirconia, or alumina.

The third particles 15 according to the embodiment can be in the form of particles for forming an uneven structure. The third particles 15 preferably have an average particle size of 1 μm or more and 50 μm or less, more preferably 10 μm or more and 30 μm or less. When the third particles 15 according to the embodiment have an average particle size of 1 μm or less, the uneven structure is not easily formed, thus easily leaving smudges. At more than 50 μm, the third particles 23 may be exposed at a surface of the film. The exposure of the third particles 23 deteriorates the design. The average particle size of the third particles 23 is a number-average particle size and can be measured by a dynamic light scattering method.

The amount of the third particles 15 contained in the coating material according to the embodiment is preferably 0.5% or more by mass and 20% or less by mass, more preferably 1% or more by mass and 15% or less by mass with respect to non-volatile components in the coating material. When the amount of the third particles 15 contained is less than 0.5% by mass, the uneven structure may be sparsely distributed to deteriorate the smudge resistance. When the amount of the third particles 15 contained is more than 20% by mass, adhesion to the base member may be deteriorated. The amount of the third particles 15 contained in the coating material based on the non-volatile components can be measured by separation as sediments using centrifugation.

The amount of the second particles 17 contained in the base material 26 of the third particles 15 in the coating material according to the embodiment with respect to the base material 26 can be 15% or more by mass based on the base material and less than or equal to the amount of the first particles 24 contained with respect to the resin. The phrase “with respect to the base material” refers to mass content (%), i.e., content (% by mass), based on 100% by mass of the base material. At less than 15% by mass, the third particles 15 as a whole highly transmit visible or infrared light and thus cannot efficiently eject the light to the outside. At more than the amount of the first particles 24 contained in the resin, light incident on the third particles 15 is seemingly confined in the third particles 15 to deteriorate the heat-shielding performance.

The third particles 15 may be produced by any method. For example, the third particles 15 may be produced by the polymerization, such as suspension polymerization, of a dispersion containing the second particles 17 in a monomer to be formed into the base material 26, or by adding a curing agent to the dispersion and then pulverizing the resulting cured product with, for example, a mechanical rotary-type or jet-type pulverizer. Additionally, the resulting particles may be classified so as to have a desired particle size.

### First Particles

The first particles 16 in the coating material according to the embodiment may be composed of the same material as the second particles 17 in the third particles 15.

The amount of the first particles 16 contained in the coating material according to the embodiment is preferably 20% or more by mass and 55% or less by mass, more preferably more than 20% by mass and 45% or less by mass with respect to the resin in the coating material (based on 100% by mass of the resin in the coating material). When the amount of the first particles 16 according to the embodiment is less than 20% by mass, the heat-shielding effect is decreased. When the amount of the first particles 16 contained is more than 55% by mass, the particles are not uniformly dispersed in a coating film to cause the nonuniformity of the film. The amount of the first particles 16 contained in the coating material can be measured by separating sediments using appropriate centrifugation and analyzing the sediments with a Fourier transform infrared spectrophotometer (FT-IR).

The first particles 16 preferably have an average particle size of 10 nm or more and 5 μm or less, more preferably 100 nm or more and 1 μm or less. When the first particles 16 according to the embodiment have an average particle size of less than 10 nm, visible or infrared light cannot be effectively reflected, thereby deteriorating the heat-shielding performance. When the first particles 16 according to the embodiment have an average particle size of more than 5 μm, it is difficult to uniformly disperse the first particles 16 in the resin; thus, the heat-shielding performance may be deteriorated.

The average particle size of the first particles 16 is a number-average particle size. In the state of a coating material before application, the average particle size can be measured by a dynamic light scattering method.

### Resin

Non-limiting examples of the resin contained in the coating material according to the embodiment include epoxy resins, urethane resins, acrylic resins, urethane-acrylic resins, phenolic resins, and alkyd resins. These resins may be contained alone or in combination of two or more.

The amount of the resin contained in the coating material according to the embodiment is preferably 5% or more by mass and 80% or less by mass, more preferably 15% or more by mass and 50% or less by mass with respect to non-volatile components in the coating material (based on 100% by mass of the non-volatile components in the coating material). When the amount of the resin according to the embodiment is less than 5% by mass, adhesion to the base member may be deteriorated. When the amount of the resin according to the embodiment is more than 50% by mass, the uneven structure having smudge resistance may not be obtained. The amount of the resin in the coating material with respect to the non-volatile components can be measured by separating sediments using appropriate centrifugation and analyzing the sediments with a Fourier transform infrared spectrophotometer (FT-IR).

### Particles for Adjusting Lightness of Film

The coating material according to the embodiment may contain particles (colorant) for adjusting lightness in addition to the first particles and the second particles. In the case where the first particles or the second particles are composed of titanium oxide, the particles function as particles (white pigment) for adjusting the lightness. The material of the particles is not particularly limited. The particles can contain azo-based organic particles with high infrared reflection performance. As the azo-based organic particles, particles composed of any azo group-containing compound can be used. Examples of the color of the azo-based organic particles contained in the coating material according to the embodiment include black-based colors, yellow-based colors, red-based colors, and orange-based colors. Black-based colors can be used because of a small change in tint (a*, b*) when fading due to sunlight occurs. A material having high solar reflectance can be used. A material in which the solar reflectance of azo-based organic particles alone is more than 10% can be selected. Examples of the material of the azo-based organic particles include nickel azo pigments, insoluble azo-based pigments, soluble azo-based pigments, high-molecular-weight azo-based pigments, azomethine azo-based pigments. These materials of the azo-based organic particles may be contained alone or in combination.

The azo-based organic particles contained in the coating material according to the embodiment preferably has an average particle size of 10 nm or more and 5 μm or less, more preferably 50 nm or more and 2 μm or less. An average particle size of less than 10 nm results in an increase in the surface area of the particles to deteriorate the lightfastness, thereby possibly causing discoloration. An average particle size of more than 5 μm makes it difficult to uniformly disperse titanium oxide in the film, thereby possibly deteriorating the heat-shielding performance. The average particle size of the azo-based organic particles is a number-average particle size and can be measured by a dynamic light scattering method.

The amount of the azo-based organic particles contained in the coating material according to the embodiment is preferably 0.1% or more by mass and 1.0% or less by mass, preferably 0.15% or more by mass and 0.5% or less by mass with respect to non-volatile components in the coating material. When the amount of the azo-based organic particles contained is less than 0.1% by mass, the film has excessively high lightness; thus, smudge resistance is deteriorated. When the amount of the azo-based organic particles contained is more than 1.0% by mass, the film has insufficient lightness; thus, the solar reflectance is deteriorated. The amount of the azo-based organic particles contained in the coating material with respect to the non-volatile components can be measured by separating sediments using appropriate centrifugation and analyzing the sediments with a Fourier transform infrared spectrophotometer (FT-IR).

As particles for adjusting the lightness of the film, a material other than white pigments (first particles and second particles) or the azo-based organic particles may be contained. Examples of the material include alumina, zirconia, silica, hollow silica, zinc oxide, and pigments. These materials may be used alone or in combination. For example, fine inorganic particles and fine organic particles may be used to adjust the lightness, glossiness, and tint to desired level.

### Silica Particles

The coating material according to the embodiment may further contain silica particles. The silica particles can have an average particle size of 10 nm or more and 5 μm or less. When the silica particles according to the embodiment has an average particle size of less than 10 nm, the uneven surface structure is not easily formed; thus, smudges are easily left. An average particle size of more than 5 μm results in an increase in the unevenness of the coating film, thereby possibly deteriorating the accuracy of the film thickness.

The silica particles can have any shape. Examples of the shape of the silica particles include spherical shapes, indefinite shapes, star shapes, chain shapes, hollow shapes, and porous shapes. These silica particles may be contained alone or in combination.

The particle size of the silica particles according to the embodiment is a number-average particle size. In the state of the coating material before application, the average particle size of the silica particles can be measured by a dynamic light scattering method.

The amount of the silica particles contained is 0.5% or more by mass and 10% or less by mass, preferably 1% or more by mass and 5% or less by mass with respect to the non-volatile components in the coating material. When the amount of the silica particles contained is less than 0.5% by mass, light reflected from a surface of the film may adversely affect image quality. When the amount of the silica particles according to the embodiment is more than 10% by mass, the silica particles may be sedimented in the coating material. The amount of the silica particles in the coating material with respect to the non-volatile components can be measured by separating sediments using appropriate centrifugation and analyzing the sediments with a Fourier transform infrared spectrophotometer (FT-IR).

### Solvent

The coating material according to the embodiment further contains a solvent.

Non-limiting examples of the solvent include water, thinners, ethanol, isopropyl alcohol, n-butyl alcohol, ethyl acetate, propyl acetate, isobutyl acetate, and butyl acetate. Other examples thereof include methyl ethyl ketone, methyl isobutyl ketone, propylene glycol monomethyl ether, toluene, xylene, acetone, cellosolves, glycol ethers, and ethers. These solvents may be used alone or in combination.

The coating material according to the embodiment preferably has a viscosity of 10 mPa·s or more and 10,000 mPa·s or less, more preferably 50 mPa·s or more and 500 mPa·s or less. When the coating material has a viscosity of less than 10 mPa·s, a heat-shielding film after application may have some portions having a smaller thickness. A viscosity of more than 10,000 mPa·s may result in a deterioration in the application properties of the coating material.

### Other Additives

The coating material according to the embodiment may further contain other freely-selected additives. Examples thereof include dispersants, curing agents, curing catalysts, plasticizers, thixotropy imparting agents, leveling agents, flatting agents, preservatives, ultraviolet absorbers, antioxidants, coupling agents, and fine inorganic particles and fine organic particles other than those described above for the purpose of adjusting the tint.

### Method for Producing Coating Material

A method for producing the coating material will be described below.

Any method for producing the coating material for the formation of the film according to the embodiment may be employed as long as the resin, the first particles, and the third particles containing the second particles in the base material according to the embodiment can be dispersed in the coating material. Examples of a device for use in the method include bead mills, ball mills, jet mills, three-roll mills, planetary rotation devices, mixers, ultrasonic dispersers, and homogenizers.

### Method for Producing Article

In a method for producing an article according to the embodiment, any application method and any curing method may be employed as long as the coating material according to the embodiment can be applied to the base member to a thickness of 20 μm or more and 70 μm or less.

Examples of the application method include brush coating, spray coating, dip coating, and transfer coating. The film according to the embodiment may be formed by single-layer coating or multilayer coating. Regarding the curing method, the resulting coating film may be allowed to stand at room temperature, may be heated to promote curing, or may be cured by irradiation with ultraviolet radiation. Examples of a method for curing by the application of heat include a method using a heating oven, a method using a heater, and a method using infrared heating. The curing temperature is preferably in the range of room temperature to 400° C., more preferably room temperature to 200° C.

As described above, the article according to the embodiment includes the film (film according to the embodiment) having excellent heat-shielding performance on a surface thereof, the film being formed by applying the coating material according to the embodiment to the base member.

### Second Embodiment

FIG. 2B is a sectional view of a digital single-lens reflex camera to which an interchangeable lens as an example of an optical apparatus according to the embodiment is attached, the interchangeable lens including a lens barrel having a holding unit configured to hold lens elements.

The optical apparatus according to the embodiment refers to an apparatus, such as a binocular, a microscope, a semiconductor exposure apparatus, an interchangeable lens, or a camera, provided with an optical system including an optical element. Alternatively, the optical apparatus refers to an apparatus configured to form an image using light passing through an optical element. The optical apparatus according to the embodiment may also be an apparatus including an electronic device, such as a camera system, e.g., a digital still camera or digital camcorder, or a cellular phone, having an image pickup device configured to receive light passing through an optical element according to an embodiment. An image pickup device may also be in the form of a module, such as a camera module, mounted on the apparatus.

The optical apparatus according to the embodiment may also be, for example, a camera body, a camcorder body, surveillance camera, or a weather camera, which is an image forming apparatus configured to form an image using light passing through its lens and which is possibly used outdoors. The optical apparatus according to the embodiment includes the film according to the embodiment disposed on a portion of the optical apparatus to be irradiated with sunlight (referred to as an “outer surface”) when used outdoors, and thus provides a higher heat-shielding effect. The optical apparatus according to the embodiment includes an electronic device installed inside the base member 1 on which the film according to the embodiment is disposed on the outer surface and thus can suppress the influence of heat on the electronic device.

In FIG. 2B, reference numeral 602 denotes a camera body, and reference numeral 620 denotes the outer barrel member of a lens barrel. The film according to an embodiment of the present invention is disposed on a surface of the outer barrel member. In FIG. 2B, the camera body 602 is attached to an interchangeable lens 601 including the outer barrel member 620 of the lens barrel. The interchangeable lens 601 is detachably mounted on the camera body 602.

Light from a photographic subject passes through an optical system including, for example, multiple lens elements 603 and 605 arranged on the optical axis of a photographing optical system in the interchangeable lens 601 and is received by an image pickup device.

The lens element 605 is supported by the holding unit provided in an inner barrel member 604 of the lens barrel and movably supported for focusing and zooming with respect to the outer barrel member 620 of the lens barrel.

During an observation period before shooting, light from a photographic subject is reflected from a main mirror 607 in a housing 621 of the camera body and passes through a prism 611, thereby displaying a shooting image to a photographer through a finder lens 612. The main mirror 607 is, for example, a half mirror. Light passing through the main mirror is reflected from a sub-mirror 608 toward an autofocus (AF) unit 613. For example, the reflected light is used for focusing. The main mirror 607 is mounted and supported on a main-mirror holder 640 by bonding or the like. At the time of shooting, the main mirror 607 and the sub-mirror 608 are moved out of an optical path by means of a drive mechanism (not illustrated). A shutter 609 is opened to form a photographic light image incident from the interchangeable lens 601 on an image pickup device 610. A diaphragm 606 is configured to change the brightness and the depth of focus during shooting by changing the opening area.

### EXAMPLES

Examples of the present invention will be described below.

The preparation of coating materials, the production of films, and the evaluation of the films in Examples 1 to 3 were performed by methods described below.

### Determination of Particle Size and Content

A measurement sample was measured in a film state. For the measurement sample, a film according to an embodiment of the present invention was formed on a polycarbonate resin plate measuring 50 mm wide, 70 mm long, and 1 mm thick and used. That is, a coating material was applied to the polycarbonate resin plate with a spin coater to a desired thickness and baked. The baked film was cut in a direction parallel to a direction normal to a surface of the film, and a section was magnified with a scanning electron microscope (trade name: ULTRA 55, available from Carl Zeiss). A target substance was subjected to surface analysis by energy dispersive X-ray spectroscopy (EDS) (trade name X-Flash 4010, available from Bruker AXS). The particle sizes of particles were determined and then averaged. Regarding the third particles, the particle sizes of 10 or more particles per location were determined and then averaged. Finally, the resulting average values at five locations were averaged.

The amount of a target substance contained was measured as follows: Cross sections of a film according to an embodiment were taken at five locations and magnified with a scanning electron microscope (trade name: ULTRA 55, available from Carl Zeiss). The cross sections of the film were cut out in the direction parallel to the direction normal to the surface of the film. The target substance located at the five locations were subjected to surface analysis by energy dispersive X-ray spectroscopy (EDS) (trade name: X-Flash 4010, available from Bruker AXS), and the amounts of the target substance contained per unit area were calculated. Finally, the amount of the target substance contained in the film according to the example was calculated from the average values at the five locations, and the resulting value was defined as the amount of the target substance (% by area) contained in the film.

### Evaluation of Solar Reflectance

Evaluation of solar reflectance will be described below. The solar reflectance was determined by measuring reflectance with a spectrophotometer (U-4000, available from Hitachi High-Tech Corporation) and then converting the resulting reflectance into solar reflectance.

Reflectance was measured by allowing light having a wavelength of 300 nm to 2,500 nm to be incident thereon. According to JIS K5602 (determination of reflectance of solar radiation by paint film), the measured reflectance was multiplied by a weighting value (weighting factor) and then integrated. The solar reflectance was calculated from the integrated value.

A measurement sample was formed as follows: A film according to an embodiment of the present invention was formed on a polycarbonate resin plate measuring 50 mm wide, 70 mm long, and 1 mm thick and used. That is, the coating material was applied to the polycarbonate resin plate with a spin coater to a desired thickness and baked.

Regarding the solar reflectance, a film having a solar reflectance of 60% or more is rated as a very good film because it is highly effective in reducing the temperature. A film having a solar reflectance of 50% or more and less than 60% is rated as a good film because it is relatively highly effective in reducing the temperature. A film having a solar reflectance of less than 50% is not highly effective in reducing the temperature.

### Rating on Scale of Three Grades: A to C

A: A solar reflectance of 60% or more.
B: A solar reflectance of 50% or more and less than 60%.
C: A film having a solar reflectance of less than 50% and higher than Comparative example 1.

### Heat-Shielding Effect

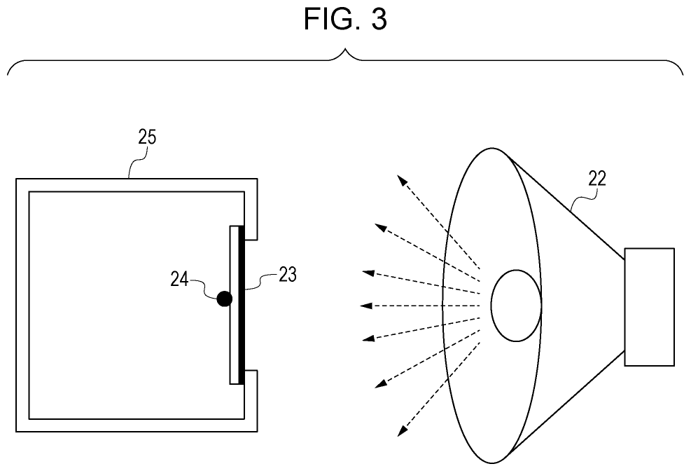

FIG. 3 is a schematic view illustrating a temperature evaluation method. As illustrated in FIG. 3, a lamp 22, a temperature measurement jig 25, and a test piece 23 for temperature evaluation were used for temperature measurement. As the test piece 23 for temperature evaluation, a film according to an embodiment of the present invention was formed on a polycarbonate resin plate measuring 50 mm wide, 70 mm long, and 1 mm thick and used. That is, a coating material was applied to the polycarbonate resin plate with a spin coater to a desired thickness and baked. As the temperature measurement jig 25, a corrugated cardboard box having a white surface and measuring 120 mm×120 mm×120 mm was used. A window section measuring 40 mm×40 mm was provided at a portion where the test piece 23 for temperature evaluation was to be attached. As the lamp 22, HILUX MT150FD 6,500 K (available from Iwasaki Electric Co., Ltd.) was used.

The test piece 23 for temperature evaluation was attached to the temperature measurement jig 25. A thermocouple 24 was attached to the back surface of the test piece 23 for temperature evaluation. The temperature measurement jig 25 to which the test piece 23 for temperature evaluation was attached was placed so as to be spaced 100 mm apart from the lamp 22. The test piece 23 was irradiated with light emitted from the lamp 22 for 60 minutes. The temperature after 60 minutes was measured.

The temperature reduction effect was determined as follows: A black blank was formed on a surface of the test piece 23 for temperature evaluation, and then the temperature measurement was performed. The difference between the resulting temperature and the temperature measurement result of the film in each of the examples was calculated and defined as a temperature reduction effect.

The black blank was formed as follows: 20 g of carbon black (MA100, available from Mitsubishi Chemical Corporation), 100 g of an epoxy resin (jER 828, available from Mitsubishi Chemical Corporation), 70 g of an amine curing agent (ST11, available from Mitsubishi Chemical Corporation), and 20 g of a thinner were mixed using a planetary rotation device to prepare a coating material. The coating material was applied to a surface of the test piece 23 and baked.

A film with a temperature reduction effect of 7° C. or higher is rated as a film having a very high heat-shielding effect. A film with a temperature reduction effect of 3° C. or higher and lower than 7° C. is rated as a film having a relatively high heat-shielding effect.

### Rating on Scale of Three Grades: A to C

A: A temperature reduction effect of 7° C. or higher.
B: A temperature reduction effect of 3° C. or higher and lower than 7° C.
C: A temperature reduction effect of lower than 3° C. and higher than Comparative example 1.

### Evaluation of Smudge Resistance of Film

For the evaluation of the smudge resistance of the film, gloss was measured with a gloss meter. For a measurement sample, a film according to an embodiment of the present invention was formed on a polycarbonate resin plate measuring 50 mm wide, 70 mm long, and 1 mm thick and used. That is, a coating material was applied to the polycarbonate resin plate with a spin coater to a desired thickness and baked. After the baking, the gloss value of the film according to an embodiment of the present invention was measured with the gloss meter. Next, fingerprints were left on the sample with bare hands, and then the gloss value of the film of an embodiment of the present invention was measured.

Gloss change Δ=gloss after leaving fingerprint−gloss before leaving fingerprint

A film with a gloss change Δ of less than 0.5 is rated as a film having a very small change in gloss and a good smudge resistance effect. A film with a gloss change Δ of 0.5 or more and less than 1.0 is rated as a film having a good smudge resistance effect. When a film has a gloss change Δ of 1.0 or more, it is not to say that the film has no smudge resistance effect, but has a small smudge resistance effect.

### Rating on Scale of Three Grades: A to C

A: A gloss change of less than ±0.5.
B: A gloss change of ±0.5 or more and less than ±1.0.
C: A gloss change of ±1.0 or more.

### Production of Third Particles

First, 125 g of a resin (Olester Q-691, available from Mitsui Chemicals, Inc.), 6.5 g of a dispersant, 32 g of titanium oxide (D-970, available from Sakai Chemical Industry Co., Ltd., average particle size: 0.26 μm, silica-coated surface), and 90 g of a thinner were weighed and mixed together with a ball mill for 15 hours to prepare a white coating material 1.

White coating materials 2, 3, 4, and 5 were prepared in the same way as above, except that titanium oxide was used in amounts of 41 g, 84 g, 188 g, and 400 g, respectively.

The resulting white coating materials were used as base formulations. Next, 10 g of each of the base formulations was cured by mixing with 1 g of a curing agent (Takenate D-120N, available from Mitsui Chemicals, Inc.) to provide a cured product.

The resulting cured products are each pulverized with a mechanical rotary-type pulverizer and then classified into particles having a desired particle size, thereby producing third particles.

### Example 1

In Example 1, a coating material was prepared by the following method: 125 g of a resin, 0.5 g of an azo-based pigment, and 145 g of titanium oxide (corresponding to a titanium oxide content of 23% by area in a film), the third particles 1 (titanium oxide content in a base material: 6%, content by area in a film: 20%, average particle size: 20 μm) produced from the white coating material 1, 5 g of silica, 5 g of a dispersant, and 100 g of a solvent were weighed and mixed with a ball mill for 15 hours to prepare a base formulation. Then 10 g of the resulting base formulation was mixed with 1 g of a curing agent to prepare a coating material of Example 1.

As the resin, Olester Q-691 (available from Mitsui Chemicals, Inc.) was used. As the azo-based organic particles, Chromofine Black A1103 (available from Dainichiseika Color & Chemicals Mfg. Co., Ltd.) was used. As the titanium oxide, D-970 (available from Sakai Chemical Industry Co., Ltd., average particle size: 0.26 μm, silica-coated surface) was used. As the silica, ACEMATT-OK607 was used. As the curing agent, Takenate D-120N (available from Mitsui Chemicals, Inc.) was used.

### Production of Film

In Example 1, a film was produced by the following method: The coating material described above was applied to a polycarbonate plate with a spin coater to a thickness of 30 μm, dried at room temperature overnight, and baked at 110° C. for 30 minutes to provide a film of Example 1.

### Examples 2 to 7

Coating materials and films of Examples 2 to 4 were produced as in Example 1, except that third particles produced using a white coating material 2 were used in Example 2, third particles produced using a white coating material 3 were used in Example 3, third particles produced using a white coating material 4 were used in Example 4, and conditions given in Table 1 were used. Coating materials and films of Examples 5 to 7 were produced as in Example 1, except that the third particles produced using the white coating material 1 were used, and the conditions given in Table 1 were used.

### Example 8

A coating material and a film of Example 8 were produced as in Example 1, except that commercially available acrylic polymer particles (available from Dainichiseika Color & Chemicals Mfg. Co., Ltd., trade name: Rubcouleur 010(F) White, average particle size: 20 μm, titanium oxide content in a base material: 23%) were used as the third particles, and the conditions given in Table 1 were used.

### Examples 9 to 11

Coating materials and films of Examples 9 to 11 were produced as in Example 1, except that large particle-sized white particles produced using a white coating material 5 were used in Example 9, large particle-sized white particles produced using the white coating material 3 were used in Example 10, large particle-sized white particles produced using the white coating material 4 were used in Example 11, and the conditions given in Table 1 were used.

### Comparative Examples 1 and 2

Coating materials and films of Comparative examples 1 and 2 were produced as in Example 1, except that resin particles produced by pulverizing and classifying a cured product, which was produced by the addition of 1 g of a curing agent (Takenate D-120N, available from Mitsui Chemicals, Inc.) to 10 g of a resin (Olester Q-691, available from Mitsui Chemicals, Inc.), were used in place of the third particles, and the conditions given in Table 1 were used.

TABLE 1

| | | | Example | Example | Example | Example | Example | Example |
|---|---|---|---|---|---|---|---|---|
| | | | 1 | 2 | 3 | 4 | 5 | 6 |
| Film | First | Material | titanium | titanium | titanium | titanium | titanium | titanium |
| | particles | | oxide | oxide | oxide | oxide | oxide | oxide |
| | | Average | 0.3 | 0.3 | 0.3 | 0.3 | 0.3 | 0.3 |
| | | particle | | | | | | |
| | | size (μm) | | | | | | |
| | | Content (% by area) | 23 | 10 | 23 | 30 | 23 | 23 |
| | Third | Average | 20 | 50 | 20 | 20 | 5 | 30 |
| | particles | particle | | | | | | |
| | | size (μm) | | | | | | |
| | | Content (% by area) | 20 | 85 | 20 | 20 | 20 | 20 |

| | | | | | | | |
|---|---|---|---|---|---|---|---|
| Base | Material | acrylic | acrylic | acrylic | acrylic | acrylic | acrylic |
| material | | | | | | | |
| Second | Material | titanium | titanium | titanium | titanium | titanium | titanium |
| particles | | oxide | oxide | oxide | oxide | oxide | oxide |
| | Average | 0.3 | 0.3 | 0.3 | 0.3 | 0.3 | 0.3 |
| | particle | | | | | | |
| | size (μm) | | | | | | |
| | Content with | 6 | 8 | 15 | 28 | 6 | 6 |
| | respect to | | | | | | |
| | base material | | | | | | |
| | (% by area) | | | | | | |

| | | | | | | | |
|---|---|---|---|---|---|---|---|
| Evaluation | Solar reflectance | A | A | A | A | A | A |
| | Heat-shielding effect | A | A | A | B | A | B |
| | Smudge resistance | A | A | A | A | B | A |

| | | | Example | Example | Example | Example | Example |
|---|---|---|---|---|---|---|---|
| | | | 7 | 8 | 9 | 10 | 11 |
| Film | First | Material | titanium | titanium | titanium | titanium | titanium |
| | particles | | oxide | oxide | oxide | oxide | oxide |
| | | Average | 3 | 0.3 | 0.3 | 0.3 | 0.3 |
| | | particle | | | | | |
| | | size (μm) | | | | | |
| | | Content (% by area) | 23 | 23 | 23 | 23 | 10 |
| | Third | Average | 20 | 20 | 20 | 3 | 20 |
| | particles | particle | | | | | |
| | | size (μm) | | | | | |
| | | Content (% by area) | 20 | 20 | 20 | 20 | 20 |

| | | | | | | |
|---|---|---|---|---|---|---|
| Base | Material | acrylic | acrylic | acrylic | acrylic | acrylic |
| material | | | | | | |
| Second | Material | titanium | titanium | titanium | titanium | titanium |
| particles | | oxide | oxide | oxide | oxide | oxide |
| | Average | 0.3 | 0.3 | 0.3 | 0.3 | 0.3 |
| | particle | | | | | |
| | size (μm) | | | | | |
| | Content with | 6 | 23 | 45 | 15 | 28 |
| | respect to | | | | | |
| | base material | | | | | |
| | (% by area) | | | | | |

| | | | | | | |
|---|---|---|---|---|---|---|
| Evaluation | Solar reflectance | A | A | B | A | C |
| | Heat-shielding effect | A | B | C | A | C |
| | Smudge resistance | A | A | A | C | A |

TABLE 2

| | | | Comparative | Comparative |
|---|---|---|---|---|
| | | | example 1 | example 2 |
| Film | First | Material | titanium | titanium |
| | particles | | oxide | oxide |
| | | Average | 0.3 | 0.3 |
| | | particle | | |
| | | size (μm) | | |
| | | Content (% by area) | 23 | 10 |
| | Third | Average | 20 | 50 |
| | particles | particle | | |
| | | size (μm) | | |
| | | Content (% by area) | 20 | 85 |

| | | | |
|---|---|---|---|
| Base | Material | acrylic | acrylic |
| material | | | |
| Second | Material | — | — |
| particles | Average | — | — |
| | particle | | |
| | size (μm) | | |
| | Content with | — | — |
| | respect to | | |
| | base material | | |
| | (% by area) | | |

| | | | |
|---|---|---|---|
| Evaluation | Solar reflectance | — | — |
| | Heat-shielding effect | — | — |
| | Smudge resistance | A | A |

### Evaluation Result

Tables 1 and 2 present the evaluation results.

In the film of Example 1, the solar reflectance was 60% or more, and the temperature reduction effect (heat-shielding effect) was 7° C. or higher, which were very good. The smudge resistance (gloss change) was less than ±0.5, which was significantly good. In Example 2 in which the average particle size and the amount of the third particles and other conditions were changed unlike Example 1, the solar reflectance, heat-shielding effect, and the smudge resistance were very good. In Example 3 in which the amount of the second particles contained in the base material of the third particles was changed to 15% unlike Example 1, the solar reflectance, the heat-shielding effect, and the smudge resistance were very good. In Example 4, unlike Example 1, the amount of the second particles contained in the base material of the third particles was changed to 28%, and the amount of the first particles contained in the film was changed to 30%. In the film of Example 4, the heat-shielding effect was 3° C. or higher and lower than 7° C., which was good. The solar reflectance and the smudge resistance (gloss change) were very good. In Example 5 in which the average particle size of the third particles was changed to 5 μm unlike Example 1, the smudge resistance was less than ±0.5 or more and less than ±1.0, which was good. The solar reflectance and the heat-shielding effect were very good. In Example 6 in which the average particle size of the third particles was changed to 30 μm unlike Example 1, the heat-shielding effect was 3° C. or higher and lower than 7° C., which was good. The solar reflectance and the smudge resistance (gloss change) were very good. In Example 7 in which the average particle size of the first particles was changed to 3 μm unlike Example 1, the solar reflectance, the heat-shielding effect, and the smudge resistance were very good. In Example 8 in which the commercially available acrylic polymer particles were used in place of the third particles unlike Example 1, the heat-shielding effect was 3° C. or higher and lower than 7° C., which was good. The solar reflectance and the smudge resistance (gloss change) were very good. In Example 9, the smudge resistance was very good. The solar reflectance was 50% or more and less than 60%, which was good. The heat-shielding effect was higher than that in Comparative example 1, and the temperature reduction effect was lower than 3° C. In Example 10 in which the average particle size of the third particles was changed to 3 μm unlike Example 1, the solar reflectance and the heat-shielding effect were very good. Regarding the smudge resistance, the gloss change was ±1.0 or more. Thus, the smudge resistance effect was lower than in Example 1. In Example 11, unlike Example 1, the amount of the second particles contained in the base material of the third particles was changed to 28%, and the amount of the first particles contained in the film was changed to 10%. In the film of Example 11, the smudge resistance was very good. The solar reflectance was less than 50%. Regarding the heat-shielding effect, the temperature reduction effect was lower than 3° C. The solar reflectance and the heat-shielding effect were higher than those in Comparative example 1.

In Comparative example 1 in which the resin particles not containing the second particles were used in place of the third particles unlike Example 1, although the smudge resistance was very good, the solar reflectance and the heat-shielding effect were both poor. In Comparative example 2 in which the resin particles not containing the second particles were used in place of the third particles unlike Example 2, although the smudge resistance was very good, the solar reflectance and the heat-shielding effect were both poor.

Embodiments of the present invention can provide an article, an optical apparatus, and a coating material having excellent smudge resistance for preventing leaving smudges, such as fingerprints, and having excellent heat-shielding properties against sunlight.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-221443 filed Dec. 6, 2019, which is hereby incorporated by reference herein in its entirety.

What is claimed is:

1. An article, comprising:
a film on a base member, the film at least containing:
a resin,
first particles, and
third particles containing second particles in a base material.

2. The article according to claim 1, wherein an amount of the first particles contained with respect to the resin is 10% or more by area and 80% or less by area based on 100% by area of the resin.

3. The article according to claim 2, wherein an amount of the second particles contained with respect to the base material is 5% or more by area based on 100% by area of the base material and less than or equal to the amount of the first particles contained with respect to the resin.

4. The article according to claim 1, wherein the first particles and the second particles contain rutile titanium oxide as a main component.

5. The article according to claim 1, wherein the resin is an acrylic resin.

6. The article according to claim 5, wherein the base material is an acrylic resin.

7. The article according to claim 1, wherein the first particles have an average particle size of 10 nm or more and 5 μm or less.

8. The article according to claim 7, wherein the second particles have an average particle size of 10 nm or more and 5 μm or less.

9. The article according to claim 8, wherein the third particles have an average particle size of more than 5 μm and 50 μm or less.

10. The article according to claim 1, wherein the film further contains silica particles.

11. The article according to claim 1, wherein the base member includes a primer.

12. The article according to claim 1, wherein the base member on which the film is disposed is an outer barrel member of a lens barrel.

13. The article according to claim 1, wherein an electronic device is placed inside the base member on which the film is disposed.

14. A coating material, comprising:
a resin;
first particles; and
third particles containing second particles in a base material.

15. The coating material according to claim 14, wherein an amount of the first particles contained with respect to the resin is 20% or more by mass and 55% or less by mass based on 100% by mass of the resin.

16. The coating material according to claim 15, wherein an amount of the second particles contained with respect to the base material is 15% or more by mass based on 100% by mass of the base material and less than or equal to the amount of the first particles contained with respect to the resin.

17. The coating material according to claim 14, wherein the first particles and the second particles contain rutile titanium oxide as a main component.

18. The coating material according to claim 14, wherein the resin is an acrylic resin.

19. The coating material according to claim 18, wherein the base material is an acrylic resin.

20. The coating material according to claim 14, wherein the first particles have an average particle size of 10 nm or more and 5 μm or less.

21. The coating material according to claim 20, wherein the second particles have an average particle size of 10 nm or more and 5 μm or less.

22. The coating material according to claim 21, wherein the third particles have an average particle size of more than 5 μm and 50 μm or less.

23. The coating material according to claim 14, further comprising:
silica particles.

24. A method for producing an article, comprising:
applying the coating material according to claim 14 to a base member to produce an article.
